(19) United States
(12) Patent Application Publication
(10) Pub. No.: US 2025/0322480 A1
(43) Pub. Date: Oct. 16, 2025

(54) VEHICLE DISPATCH DEVICE AND NON-TRANSITORY COMPUTER-READABLE RECORDING MEDIUM

(71) Applicant: TOYOTA BOSHOKU KABUSHIKI KAISHA, Aichi (JP)

(72) Inventors: Tomoya KITAZAKI, Aichi (JP); Shinji SUMITANI, Aichi (JP); Hiroyuki YAMASHIRO, Aichi (JP)

(73) Assignee: TOYOTA BOSHOKU KABUSHIKI KAISHA, Aichi (JP)

(21) Appl. No.: 19/171,637

(22) Filed: Apr. 7, 2025

(30) Foreign Application Priority Data
Apr. 15, 2024 (JP) 2024-065574

(51) Int. Cl. G06Q 50/47

(52) U.S. Cl. CPC G06Q 50/47

(57) ABSTRACT

A vehicle dispatch device assigns a driver to a user on the basis of third evaluation values measuring how easily the user gets motion sickness due to driver's driving, each of the third evaluation values being obtained on the basis of a corresponding one of first evaluation values and a corresponding one of second evaluation values, the first evaluation values measuring, for the driver of a vehicle within a predetermined distance from a riding point of the user, driving skill in terms of a respective plurality of driving items which can induce motion sickness, the second evaluation values measuring how easily the user gets motion sickness due to the respective plurality of driving items.

This Nonprovisional application claims priority under 35 U.S.C. § 119 on Patent Application No. 2024-065574 filed in Japan on Apr. 15, 2024, the entire contents of which are hereby incorporated by reference.

### TECHNICAL FIELD

The present disclosure relates to a vehicle dispatch device and a non-transitory computer-readable recording medium.

### BACKGROUND ART

Patent Literature 1 discloses a technique according to which, upon reception of a request for ride sharing, a compatibility score which measures a compatibility between a passenger and a driver is calculated and a driver assigned to the passenger is selected on the basis of the compatibility score.

### CITATION LIST

### Patent Literature

[Patent Literature 1]

Specification of U.S. Patent Application Publication No. 2018/0089605

### SUMMARY OF INVENTION

### Technical Problem

In the technique disclosed in Patent Literature 1, a risk of motion sickness is not taken into adequate consideration.

An aspect of the present disclosure has an object to provide a vehicle dispatch service which takes motion sickness into consideration.

### Solution to Problem

In order to attain the above object, a vehicle dispatch service in accordance with an aspect of the present disclosure is a vehicle dispatch device which provides a vehicle dispatch service for assigning, to a user, a driver who drives a vehicle, the vehicle dispatch device including: a first obtaining section configured to obtain first evaluation values pertaining to the driver of the vehicle which is present within a predetermined distance from a riding point where the user gets on the vehicle, the first evaluation values measuring driving skill in terms of a respective plurality of driving items capable of inducing motion sickness; a second obtaining section configured to obtain second evaluation values measuring how easily the user gets motion sickness due to the respective plurality of driving items; a third obtaining section configured to obtain, on a basis of the first evaluation values and the second evaluation values, third evaluation values measuring how easily the user gets motion sickness due to driver's driving; and a person-in-charge determining section configured to determine, on a basis of the third evaluation values, the driver to be assigned to the user.

The vehicle dispatch device in accordance with each aspect of the present disclosure may be realized by a computer. In this case, the present disclosure encompasses: a program for causing a computer to operate as each of the sections (software elements) included in the vehicle dispatch device so that the vehicle dispatch device is realized by the computer; and a computer-readable recording medium in which the program is stored.

### Advantageous Effects of Invention

In accordance with an aspect of the present disclosure, it is possible to realize a vehicle dispatch service which takes motion sickness into consideration.

### BRIEF DESCRIPTION OF DRAWINGS

FIG. 1 is a block diagram illustrating an example of a configuration of a vehicle dispatch system which uses a vehicle dispatch device in accordance with an embodiment of the present disclosure.

FIG. 2 is a view illustrating an example of a configuration of the vehicle dispatch device in accordance with the embodiment of the present disclosure.

FIG. 3 is a view used for explanation of a process carried out by an accepting section.

FIG. 4 is a view used for explanation of a process carried out by a person-in-charge determining section.

FIG. 5 is a view used for explanation of a process carried out by a fifth obtaining section and an updating section.

### DESCRIPTION OF EMBODIMENTS

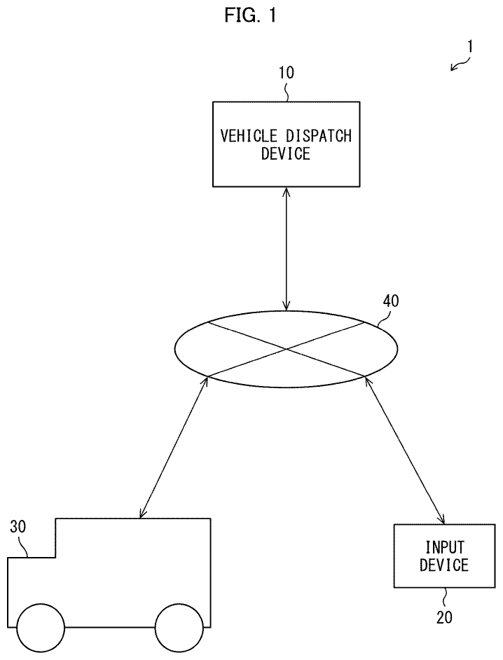

FIG. 1 is a block diagram illustrating an example of a configuration of a vehicle dispatch system which uses a vehicle dispatch device in accordance with an embodiment of the present disclosure. The vehicle dispatch system 1 shown in FIG. 1 includes a vehicle dispatch device 10, an input device 20, and a vehicle 30. The vehicle dispatch device 10 is, for example, a server which provides a vehicle dispatch service, and is connected to a network 40. The network 40 is, for example, a wireless communication network, an Internet network, a telephone line network, or the like.

The vehicle dispatch service includes a taxi dispatch service and a ride sharing service. The ride sharing service is a service which supports, to an extent permitted by a law such as the road transport law, ride sharing allowing a user who wishes to travel to the same destination as a driver of a vehicle 30 to ride the vehicle 30.

The input device 20 is an information terminal which can use the vehicle dispatch service provided by the vehicle dispatch device 10 and which accepts given input operation from a user who receives the vehicle dispatch service. For example, the input device 20 is a smartphone which can execute an application, an add-on, and/or the like for using the vehicle dispatch service and which includes a display section for displaying an operation screen and an input section such as a touch panel. The input device 20 may obtain a current position of the input device 20 on the basis of, e.g., a signal received from a GPS satellite. The input device 20 is connected to the network 40, and transmits information such as information input by the user and/or information pertaining to the current position to the vehicle dispatch device 10 via the network 40. The input device 20 may be a dedicated input terminal for utilizing a vehicle dispatch service provided to, e.g., a taxi stand and/or a bus stop.

The vehicle 30 is a vehicle which is a subject to be assigned to the user in the vehicle dispatch service provided by the vehicle dispatch device 10. Examples of the vehicle 30 include a taxi and a shared bus. The vehicle 30 is connected to the network 40 via a vehicle communication network such as controller area network (CAN).

In the vehicle dispatch device 10, information pertaining to the driver of the vehicle 30 is stored. The information pertaining to the driver includes information pertaining driving skill of the driver. The information pertaining to the driving skill includes pieces of information each measuring a possibility of inducing motion sickness due to a respective one of driving items which can induce motion sickness. Examples of the driving skills include acceleration and deceleration during straight driving, acceleration and deceleration during curving, and start and stop of the vehicle 30. For example, a driver who is likely to cause so-called hard braking, which is braking causing the vehicle 30 to be shaken in a pitch direction at an acceleration of not less than a given threshold when the vehicle 30 stops, is evaluated as having a high possibility of inducing motion sickness by stopping operation.

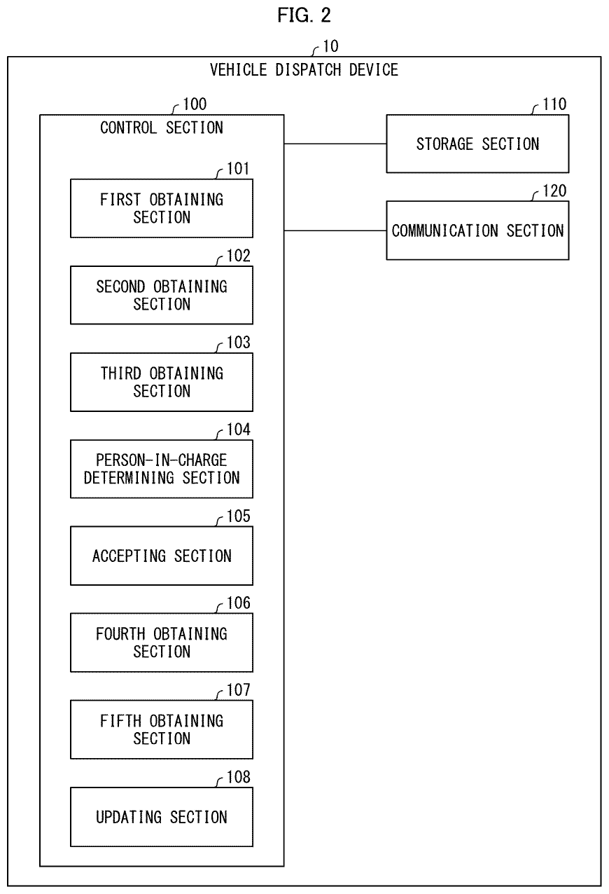

FIG. 2 is a view illustrating an example of a configuration of a vehicle dispatch device in accordance with an embodiment of the present disclosure. As shown in FIG. 2, the vehicle dispatch device 10 includes a control section 100, a storage section 110, and a communication section 120.

The control section 100 includes, for example, a central processing unit (CPU) and a main storage device. The storage section 110 includes, for example, a hard disk drive (HDD) and/or a solid state drive (SSD). In the storage section 110, a program for executing the control section 100 is stored. The communication section 120 is connected to the network 40, and communicates with the input device 20 and the vehicle 30 via the network 40. Further, in the storage section 110, information that the control section 100 has obtained via the communication section 120 is stored. Explanation of how the control section 100 obtains information will be given later.

The control section 100 executes the program stored in the storage section 110, so as to function as a first obtaining section 101, a second obtaining section 102, a third obtaining section 103, a person-in-charge determining section 104, an accepting section 105, a fourth obtaining section 106, a fifth obtaining section 107, and an updating section 108.

The first obtaining section 101 obtains first evaluation values pertaining to a driver of the vehicle 30 which is present within a predetermined distance from a riding point where a user gets on the vehicle, the first evaluation values measuring driving skill in terms of the respective plurality of driving items which can induce motion sickness. The plurality of driving items which can induce motion sickness include, for example, acceleration and deceleration during straight driving, acceleration and deceleration during curving, and start and stop of the vehicle 30. A higher first evaluation value indicates a higher possibility of inducing motion sickness.

The riding point refers to (a) a current position of the input device 20 or (b) a position at which the user wishes to ride the vehicle and which is input via the input device 20. In a case where the input device 20 is a portable information terminal, the current position of the input device 20 may be obtained, for example, on the basis of a signal received from a GPS satellite and/or the like. In a case where the input device 20 is an information terminal provided in a given riding spot, the first obtaining section 101 may obtain, as the riding point, a position at which the input device 20 is provided.

The first evaluation values can be obtained by any method. For example, the first obtaining section 101 may obtain, from the storage section 110, evaluation values pertaining to driving of the vehicle 30 carried out by the driver in the past; then, the first obtaining section 101 may obtain, as a first evaluation value for each of the driving items, an average value, a median value, or a mode value of the evaluation values.

The second obtaining section 102 obtains second evaluation values measuring how easily the user gets motion sickness due to the respective plurality of driving items which can induce motion sickness. The second evaluation values for each user are stored in the storage section 110. The driving items for which the second obtaining section 102 obtains the second evaluation values include at least a driving item for which the first obtaining section 101 obtains the first evaluation value. A higher second evaluation value indicates that the user gets motion sickness more easily due to the driving item.

The third obtaining section 103 obtains, on the basis of the first evaluation values obtained by the first obtaining section 101 and the second evaluation values obtained by the second obtaining section 102, third evaluation values measuring how easily the user gets motion sickness due to driver's driving. For example, the third obtaining section 103 obtains each of the third evaluation values for the respective plurality of driving items which can induce motion sickness, on the basis of a product of a corresponding one of the first evaluation values of the driver and a corresponding one of the second evaluation values of the user. An example of a method for calculating the third evaluation value is expressed by Formula (1).

$$Third evaluation value = first evaluation value \times second evaluation value \times correction value \qquad ( 1 )$$

A higher third evaluation value indicates that the user gets motion sickness more easily due to the driver's driving. For example, in a case of a combination of (a) a driver who is highly likely to cause hard braking and (b) a user who is likely to get motion sickness easily due to hard braking, a first evaluation value and a second evaluation value for a driving item “stopping” are both high, and accordingly a third evaluation value therefor becomes high, too.

In Formula (1), the correction value is a numerical value for correcting a product of the first evaluation value of the driver and the second evaluation value of the user. Different driving items may have different correction values. Alternatively, the plurality of driving items may have a common correction value.

The correction value may be determined on the basis of one or more parameters. The parameter(s) for determining the correction value include(s) at least a destination of the user, and is/are determined in consideration of a way in which the user spends time during traveling, a physical condition of the user, and a feature of the vehicle. For example, the correction value is calculated according to Formula (2).

$$a 1 \times w 1 + a 2 \times w 2 + a 3 \times w 3 + a 4 \times w 4 \qquad ( 2 )$$

In Formula (2), w1 is a parameter relating to a destination of the user. For example, w1 increases as the destination of the user or a traveling route desired by the user separates farther from a route along which the vehicle 30 is scheduled to travel.

w2 is a parameter relating to a way in which the user spends time during traveling. For example, w2 takes a high value, in a case where the user carries out a task which is likely to cause motion sickness, e.g., reading a book in the vehicle. Meanwhile, w2 decreases, in a case where the vehicle 30 has equipment desired by the user. The equipment can be, for example, a ventilation system providing an effect of improving the user's motion sickness.

w3 is a parameter relating to a physical condition of the user. For example, w3 varies depending of user's fatigue, stress, sleepiness, disease, and/or the like. w3 takes a high value, in a case where the user is in a bad physical condition.

w4 is a parameter relating to a feature of the vehicle. For example, w4 varies depending on an air conditioning setting, a smell in the cabin, a size of field of view, rocking, vibration, seat arrangement, and noise of the vehicle 30. For example, w4 increases as the smell in the cabin of the vehicle 30 becomes stronger.

a1, a2, a3, and a4 are weighting factors for the parameters w1, w2, w3, and w4, and are personalized for each user. The values of a1, a2, a3, and a4 for each user are stored in the storage section 110. For a user who uses the vehicle dispatch service for the first time, predetermined initial values are used as the values of a1, a2, a3, and a4.

The person-in-charge determining section 104 determines, on the basis of the third evaluation values, a driver to be assigned to the user. That is, the person-in-charge determining section 104 determines, on the basis of the third evaluation values, a driver who is in charge of conveyance of the user. An example of the process carried out by the person-in-charge determining section 104 will be described later.

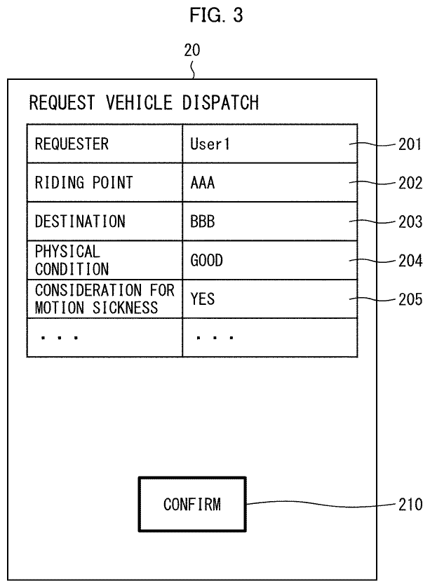

The accepting section 105 accepts information which includes at least information pertaining to the destination of the user and which is used to obtain third evaluation values. FIG. 3 is a view used for explanation of a process carried out by the accepting section. FIG. 3 illustrates an example of an input operation screen displayed on the display section of the input device 20 in order to receive the vehicle dispatch service provided. The input operation screen shown in FIG. 3 includes a client column 201, a riding point column 202, a destination column 203, a physical condition column 204, a setting column 205, and a confirm button 210.

The accepting section 105 accepts, via the client column 201, input of information for identifying a user who gives a request for vehicle dispatch. The second obtaining section 102 obtains, on the basis of the information input into the client column 201, second evaluation values and weighting factors a1, a2, a3, and a4 from the storage section 110.

The accepting section 105 accepts, via the riding point column 202, input of a riding point desired by the user. On the basis of the information input into the accepting section 105, the first obtaining section 101 obtains, from the storage section 110, first evaluation values of a driver who is a candidate for a driver assigned to the user.

The accepting section 105 accepts, via the destination column 203 and the physical condition column 204, input of information pertaining to the destination of the user and information pertaining to the physical condition of the user. The control section 100 calculates, on the basis of the information that the user has input into the destination column 203, a value of the parameter w1 relating to the destination of the user. The control section 100 calculates, on the basis of the information that the user has input into the physical condition column 204, a value of the parameter w3 relating to the physical condition of the user. The input column into which the user inputs information in order to determine values of the parameters w1, w2, w3, and w4 is not limited to the destination column 203 or the physical condition column 204. For example, an additional column into which the user can input information pertaining to the way in which the user spends time during traveling may be present.

Via the setting column 205, the accepting section 105 determines whether to take motion sickness into consideration in assigning a driver to the user. While the user is inputting, via the setting column 205, information indicating that the user wishes to take motion sickness into consideration, the person-in-charge determining section 104 determines a driver assigned to the user on the basis of the third evaluation values. The user may input, into the setting column 205, information indicating that motion sickness is not taken into consideration in assigning the driver to the user. In the case where motion sickness is not taken into consideration, the person-in-charge determining section 104 may determine the driver assigned to the use on the basis of the riding point and the destination, for example.

The fourth obtaining section 106 shown in FIG. 2 obtains information pertaining to a feature of the vehicle 30 driven by the driver. For example, a value of the parameter w4 is determined on the basis of the information obtained by the fourth obtaining section 106. For an air conditioning setting, a smell in the cabin, rocking, vibration, and noise of the vehicle 30, the fourth obtaining section 106 may obtain information from the input device 20 or a temperature sensor, an odor sensor, an acceleration sensor, and a sound collecting device provided to the vehicle 30, for example. For a size of field of view and seat arrangement, the fourth obtaining section 106 may obtain, from the storage section 110, information registered by the driver in advance.

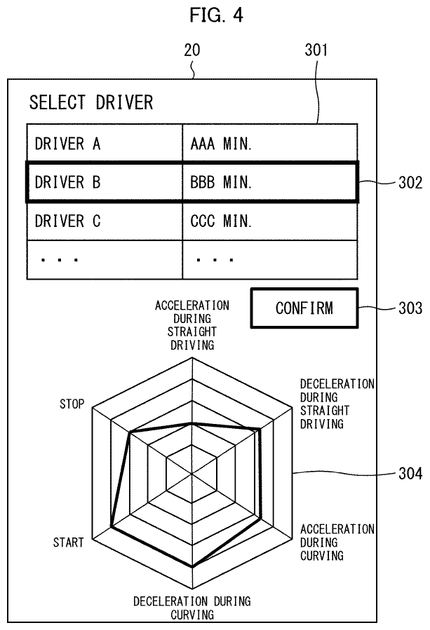

FIG. 4 is a view used for explanation of a process carried out by the person-in-charge determining section shown in FIG. 2. For example, the screen shown in FIG. 4 is an example of a person-in-charge determining screen displayed in response to operation for selecting the confirm button 210 shown in FIG. 3. In the example shown in FIG. 4, the person-in-charge determining screen indicates a driver list 301, a cursor 302, a confirm button 303, and a radar chart 304.

The driver list 301 indicates drivers on the basis of the third evaluation values obtained by the third obtaining section 103. For example, a sum total of third evaluation values of all the driving items is calculated for each of the drivers; then, the driver list 301 indicates the drivers in an ascending order of the sum total of the third evaluation values. The driver list 301 indicates, for the respective drivers, predicted time periods taken to arrive at destinations.

The radar chart 304 indicates, for a combination of the user and a driver B pointed by the cursor 302, third evaluation values for the respective driving items. In the radar chart 304 shown in FIG. 4, the third evaluation values, each being based on a product of a respective first evaluation value of the driver B and a respective second evaluation value of the user, are plotted for the respective driving items, i.e., for acceleration during straight driving, deceleration during straight driving, acceleration during curving, deceleration during curving, start, and stop. As a polygon formed by connecting six points plotted on the radar chart 304 has a smaller area, a compatibility between the driver and the driver in terms of motion sickness is better. In response to user selection of the confirm button 303, the person-in-charge determining section 104 determines, as the driver assigned to the user, the driver pointed by the cursor 302.

After the driver determined by the person-in-charge determining section 104 completes conveyance of the user, the fifth obtaining section 107 in FIG. 2 obtains information pertaining to driving having been carried out by the driver and motion sickness of the user. The updating section 108 updates, on the basis of the information obtained by the fifth obtaining section 107 and the third evaluation values, the first evaluation values of the driver determined by the person-in-charge determining section 104, the second evaluation values of the user, and the weighting factors a1, a2, a3, and a4 pertaining to the user.

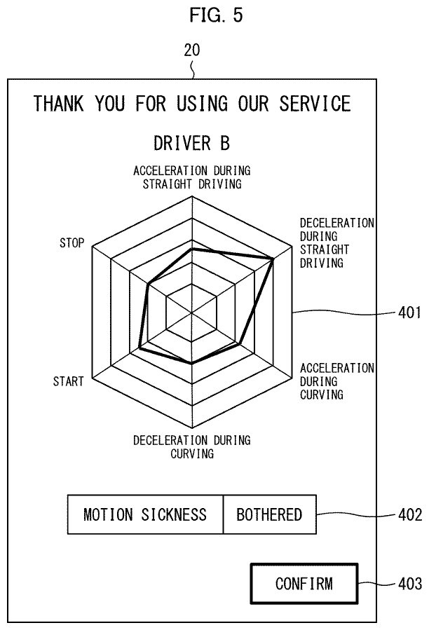

FIG. 5 is a view used for explanation of a process carried out by the fifth obtaining section and the updating section. The input screen shown in FIG. 5 indicates: a radar chart 401 indicative of evaluation values pertaining to driving having been carried out by the driver determined by the person-in-charge determining section 104; an input column 402 into which a level (intensity) of motion sickness bothering the user can be input; and a confirm button 403. The input column 402 shown in FIG. 5 can accept an input in three levels, for example, an input of “none”, “slightly bothered”, and “bothered”. In a case where the user inputs “none” into the input column 402, the level (intensity) of motion sickness of the user is 0 (zero), for example. In a case where the user inputs “slightly bothered” into the input column 402, the level (intensity) of motion sickness of the user is three, for example. In a case where the user inputs “bothered” into the input column 402, the level (intensity) of motion sickness of the user is five, for example. The input column 402 may be in (a) a format that allows a user to input a numerical value indicative of a level (intensity) for motion sickness bothering the user or (b) a format that allows a user to reply to a questionnaire about motion sickness and converts an intensity of motion sickness bothering the user into a numerical form on the basis of a result of the reply. In response to user operation of selecting the confirm button 403, the updating section 108 starts the process.

For example, the updating section 108 stores, in the storage section 110, evaluation values pertaining to driving having been carried out by the driver B determined by the person-in-charge determining section 104; then, in consideration of the evaluation values thus newly stored, the updating section 108 recalculates average values, median values, or mode values of the evaluation values in terms of the respective driving items, and updates the first evaluation values. The updating section 108 may update the first evaluation values in consideration of the third evaluation values obtained by the third obtaining section 103. For example, an evaluation value newly stored in order to recalculate a first evaluation value may be multiplied by a weighting factor for the third evaluation value.

The updating section 108 updates a second evaluation value, for example, on the basis of a corresponding one of the third evaluation values obtained by the third obtaining section 103 and content of an input made into the input column 402. For example, in a case where a difference between (a) a level of motion sickness corresponding to the content of the input made into the input column 402 and (b) a level corresponding to the third evaluation value is not less than a predetermined value, the updating section 108 updates the second evaluation value. As the level corresponding to the third evaluation value, the value of the third evaluation value may be used as it is. Alternatively, as the level corresponding to the third evaluation value, a level obtained by converting the value of the third evaluation value according to a given function may be used.

The updating section 108 updates the weighting factors a1, a2, a3, and a4 pertaining to the user by, for example, supervised learning that uses, as training data, a combination of (a) the content of the input made into the input column 402 and (b) information such as information having been input into the destination column 203 and the physical condition column 204 as well as information obtained from various sensors of the vehicle 30 when a request for vehicle dispatch is given. The updating section 108 may update the weighting factors a1, a2, a3, and a4 pertaining to the user in consideration of the third evaluation values obtained by the third obtaining section 103. For example, the third evaluation values may be included in the training data.

### (Effects)

As discussed above, the vehicle dispatch device 10 in accordance with the present embodiment can provide the following effects.

The vehicle dispatch device 10 is a server for providing the vehicle dispatch service assigning, to a user, a driver who drives the vehicle 30. The vehicle dispatch device 10 includes the first obtaining section 101, the second obtaining section 102, the third obtaining section 103, and the person-in-charge determining section 104. The first obtaining section 101 obtains first evaluation values pertaining to the driver of the vehicle 30 which is present within a predetermined distance from a riding point where the user gets on the vehicle, the first evaluation values measuring driving skill in terms of the respective plurality of driving items which can induce motion sickness. The second obtaining section 102 obtains second evaluation values measuring how easily the user gets motion sickness due to the respective plurality of driving items. The third obtaining section 103 obtains, on the basis of the first evaluation values and the second evaluation values, third evaluation values measuring how easily the user gets motion sickness due to driver's driving. The person-in-charge determining section 104 determines, on the basis of the third evaluation values, a driver to be assigned to the user. With the above configuration, it is possible to realize a vehicle dispatch service that takes motion sickness into consideration.

The third obtaining section 103 obtains each of the third evaluation values for the respective plurality of driving items on the basis of a product of a corresponding one of the first evaluation values and a corresponding one of the second evaluation values. By obtaining the third evaluation values in the above-described manner, it is possible to appropriately calculate a compatibility between the driver and the user from the viewpoint of motion sickness.

The vehicle dispatch device 10 further includes the accepting section 105 which accepts at least input of information pertaining to a destination of the user. The third obtaining section 103 obtains each of the third evaluation values by correcting a product of the corresponding one of the first evaluation values and the corresponding one of the second evaluation values on the basis of information that the accepting section 105 has accepted via the destination column 203 and the physical condition column 204. With the above configuration, it is possible to more precisely convert, into a numerical form, the compatibility between the driver and the user from the viewpoint of motion sickness.

The vehicle dispatch device 10 further includes the fourth obtaining section 106 which obtains information pertaining to a feature of the vehicle 30 driven by the driver. The third obtaining section 103 obtains a correction value by calculating the parameter w4 on the basis of information obtained by the fourth obtaining section 106. The third obtaining section 103 obtains the third evaluation values by correcting, with the correction value, the product of the corresponding one of the first evaluation values and the corresponding one of the second evaluation values. With the above configuration, it is possible to more precisely convert, into a numerical form, the compatibility between the driver and the user from the viewpoint of motion sickness.

The vehicle dispatch device 10 further includes: the fifth obtaining section 107 which obtains, after the driver determined by the person-in-charge determining section 104 completes conveyance of the user, information pertaining to driving having been carried out by the driver and motion sickness bothering the user; and the updating section 108 which updates, on the basis of the information obtained by the fifth obtaining section 107 and the third evaluation values, the first evaluation values, the second evaluation values, and at least one correction value for products of the first evaluation values and the second evaluation values.

### [Software Implementation Example]

The functions of the vehicle dispatch device 10 (hereinafter, referred to as a “device”) can be realized by a program for causing a computer to function as the device, the program causing the computer to function as the control blocks (particularly, the sections included in the control section 100) of the device.

In this case, the device includes, as hardware for executing the program, a computer that includes at least one control device (e.g., a processor) and at least one storage device (e.g., a memory). By executing the program by the control device and the storage device, the functions described in the foregoing embodiments are realized.

The program may be recorded in one or more non-transitory computer-readable recording media. The one or more recording media may or may not be included in the device. In the latter case, the program may be supplied to or made available to the device via any wired or wireless transmission medium.

Alternatively, a part or all of the functions of the control blocks can be realized by a logic circuit. For example, the present disclosure encompasses, in its scope, an integrated circuit in which a logic circuit that functions as each of the control blocks is formed. Alternatively, the functions of the control blocks can be realized, for example, by a quantum computer.

Each of the processes described in the foregoing embodiments may be executed by artificial intelligence (AI). In this case, the AI may operate in the control device or may operate in another device (e.g., an edge computer or a cloud server).

### (Variations)

In the foregoing embodiment, the third obtaining section 103 obtains each of the third evaluation values on the basis of a product of a corresponding one of the first evaluation values and a corresponding one of the second evaluation values. However, this is not limitative. For example, the third obtaining section 103 may obtain each of the third evaluation values on the basis of a sum of a corresponding one of the first evaluation values and a corresponding one of the second evaluation values. For this, the correction value may be further added to the sum of the first evaluation value and the second evaluation value; alternatively, the sum of the first evaluation value and the second evaluation value may be multiplied by the correction value. The first evaluation value may be corrected by multiplying of the first evaluation value by the correction value, and the second evaluation value may be corrected by multiplying the second evaluation value by the correction value.

In the foregoing embodiment, the correction value is calculated according to Formula (2). However, the correction value is not limited to the one calculated according to Formula (2). The correction value may be calculated according to a formula different from Formula (2), provided that the formula at least includes the parameter w1.

In the foregoing embodiment, the control section 100 calculates the value of the parameter w3 pertaining to the physical condition of the user, on the basis of the information that the user has input into the physical condition column 204. However, the method for calculating the parameter w3 pertaining to the physical condition of the user is not limited to the one which is based on the information having been input into the physical condition column 204. For example, the input device 20 may be provided with a camera; then, a face of the user may be imaged and a physical condition of the user may be estimated by using the image thus obtained. For another example, biometric information of the user, such as a body temperature, an electrocardiogram, a pulse wave, and/or a breathing state of the user, may be detected and the physical condition of the user may be estimated on the basis of the biometric information.

The present disclosure is not limited to the embodiments, but can be altered by a skilled person in the art within the scope of the claims. The present disclosure also encompasses, in its technical scope, any embodiment derived by combining technical means disclosed in differing embodiments.

### REFERENCE SIGNS LIST

10: vehicle dispatch device
30: vehicle
100: control section
101: first obtaining section
102: second obtaining section
103: third obtaining section
104: person-in-charge determining section
105: accepting section
106: fourth obtaining section
107: fifth obtaining section
108: updating section

1. A vehicle dispatch device which provides a vehicle dispatch service for assigning, to a user, a driver who drives a vehicle, the vehicle dispatch device comprising:
a first obtaining section configured to obtain first evaluation values pertaining to the driver of the vehicle which is present within a predetermined distance from a riding point where the user gets on the vehicle, the first evaluation values measuring driving skill in terms of a respective plurality of driving items capable of inducing motion sickness;
a second obtaining section configured to obtain second evaluation values measuring how easily the user gets motion sickness due to the respective plurality of driving items;
a third obtaining section configured to obtain, on a basis of the first evaluation values and the second evaluation values, third evaluation values measuring how easily the user gets motion sickness due to driver's driving; and
a person-in-charge determining section configured to determine, on a basis of the third evaluation values, the driver to be assigned to the user.

2. The vehicle dispatch device according to claim 1, wherein:
the third obtaining section obtains each of the third evaluation values for the respective plurality of driving items on a basis of a product of a corresponding one of the first evaluation values and a corresponding one of the second evaluation values.

3. The vehicle dispatch device according to claim 2, further comprising:
an accepting section configured to accept at least input of information pertaining to a destination of the user,
the third obtaining section obtaining said each of the third evaluation values by correcting the product of the corresponding one of the first evaluation values and the corresponding one of the second evaluation values on a basis of the information accepted by the accepting section.

4. The vehicle dispatch device according to claim 2, further comprising:
a fourth obtaining section configured to obtain information pertaining to a feature of the vehicle driven by the driver,
the third obtaining section obtaining said each of the third evaluation values by correcting the product of the corresponding one of the first evaluation values and the corresponding one of the second evaluation values on a basis of the information obtained by the fourth obtaining section.

5. The vehicle dispatch device according to claim 2, further comprising:
a fifth obtaining section configured to obtain, after the driver determined by the person-in-charge determining section completes conveyance of the user, information pertaining to driving having been carried out by the driver and motion sickness of the user; and
an updating section configured to update, on a basis of the information obtained by the fifth obtaining section and the third evaluation values, the first evaluation values, the second evaluation values, and at least one correction value for products of the first evaluation values and the second evaluation values.

6. A non-transitory computer-readable recording medium in which a program for causing a computer to function as a vehicle dispatch device recited in claim 1 is stored, the program causing the computer to function as the first obtaining section, the second obtaining section, the third obtaining section, and the person-in-charge determining section.
